(19) United States
(12) Patent Application Publication
(10) Pub. No.: US 2022/0109297 A1
(43) Pub. Date: Apr. 7, 2022

(54) SUPPLY SYSTEM FOR SUPPLYING ELECTRICAL VOLTAGE AND METHOD FOR OPERATING A SUPPLY SYSTEM

(71) Applicant: Frauscher Sensortechnik GmbH, St. Marienkirchen (AT)

(72) Inventors: Stefan LUGSCHITZ, Schärding (AT); Günther MADER, Altheim (AT); Rudolf THALBAUER, Hohenzell (AT)

(21) Appl. No.: 17/269,984

(22) PCT Filed: Apr. 30, 2019
(86) PCT No.: PCT/EP2019/061055

§ 371 Date: Feb. 19, 2021

(30) Foreign Application Priority Data
Aug. 21, 2018 (EP) 18189884.2

(51) Int. Cl. H02J 1/08; H02H 3/247; H02H 7/26

(52) U.S. Cl. CPC H02J 1/086; H02H 7/26; H02H 3/247

(57) ABSTRACT

The invention relates to a supply system (20) for supplying electrical voltage. The supply system (20) comprises at least one voltage supply (21), which has a voltage source (22), and at least two electrical load units (23). The electrical load units (23) each have a first input (24), a second input (25) and an electrical load (38), each of the electrical load units (23) has a switch (26), which is arranged between the first and the second input (24, 25), at least one electrical load unit (23) is electrically coupled to the voltage supply (21), the electrical loads (38) are electrically connected in parallel, and each of the electrical load units (23) is configured to autonomously control the associated switch (26). The invention further relates to a method for operating a supply system (20).

A supply system for supplying electrical voltage and a method for operating a supply system are specified.

Electrical loads may be connected to a supply system for supplying electrical voltage. For example, the electrical loads may be connected in parallel along a supply path and be supplied with electrical voltage by the supply system. For example, the electrical loads may be a plurality of sensors arranged at different positions. To protect against failures that may occur due to short circuits or voltage dips along the supply path, many supply systems have two supply paths. However, if a short circuit occurs in one of the electrical loads, both supply paths may collapse without additional protective circuitry. Thus, all electrical loads connected to the supply paths would no longer be supplied with voltage.

One object to be achieved is to specify a supply system for the supply with electrical voltage which shows improved protection against failures.

The object is achieved by the subject matter of the independent patent claim. Advantageous embodiments and further developments are indicated in the subclaims.

According to at least one embodiment of the supply system for supplying electrical voltage, the supply system comprises at least one voltage supply comprising a voltage source. The voltage supply may have at least one output which is configured such that electrical loads or electrical load units can be connected. Thus the voltage supply may be configured to provide electrical voltage. The voltage supply may be configured to provide a predefinable voltage. The voltage source may have two outputs, one of which is electrically connected to the output of the voltage supply and the other to ground. Alternatively, both outputs of the voltage source may be electrically connected to the voltage supply. In this case, the supply system can be operated in floating manner.

The supply system further has at least two electrical load units. The electrical load units may be configured to be supplied with electrical voltage.

The electrical load units each have a first input, a second input and an electrical load. The electrical load units can each be supplied with electrical voltage via the first input and the second input. The electrical loads may be sensors, for example. The sensors may be arranged along an object to be monitored. Furthermore, the sensors may be configured to detect vehicles moving along the object to be monitored. For example, the object to be monitored may be tracks on which trains move. It is also possible that the electrical loads are other electrical loads.

Each of the electrical load units comprises a switch which is arranged between the respective first and the respective second input. This can mean that the first input is electrically connected to a first side of the switch and the second input is electrically connected to a second side of the switch, the second side of the switch being arranged on a side facing away from the first side of the switch. When the switch is closed, the first input and the second input may be electrically connected to each other. When the switch is open, the first input and the second input are not electrically connected to each other via the switch. For example, the switch may be a mechanical switch or an electronic switch.

At least one electrical load unit is electrically coupled to the voltage supply. This can mean that at least one electrical load unit is electrically connected to the voltage supply. For example, one of the inputs of the electrical load unit may be electrically connected to the output of the voltage supply. The at least one electrical load unit may be connected to the voltage supply via a cable. Furthermore, it is possible that each of the electrical load units is electrically connected to the voltage supply.

The electrical load units are arranged in series. The electrical loads are electrically connected in parallel. This means that the electrical loads are electrically connected in parallel with respect to the voltage supply. For this purpose, the electrical load units can each be connected to both poles of the voltage supply. The electrical loads are each a part of an electrical load unit. The electrical load units are arranged one after the other. For example, the second input of an electrical load unit may be electrically connected to the first input of another electrical load unit. Thus, a supply path can be formed. The supply path may have electrical connections between the voltage supply and the electrical load units. For example, the supply path may have an electrical connection between the voltage supply and a first input of a first electrical load unit and the electrical connection via the switch between the first input and the second input of the first electrical load unit. Furthermore, the supply path may comprise electrical connections between the remaining electrical load units. Since the electrical load units are each connected to both poles of the voltage supply, the electrical loads of the electrical load units are electrically connected in parallel.

Each of the electrical load units is configured to drive the corresponding switch autonomously. For this purpose, each of the electrical load units may comprise a drive unit which is configured to drive the respective associated switch autonomously. This can mean that the drive unit is configured to drive the switch in such a way that it is closed or opened. The drive unit may be connected to the switch via a control connection. The control connection may be a mechanical, electrical or wireless connection.

The fact that each of the electrical load units is configured to autonomously drive the respective associated switch can mean that each of the electrical load units exclusively uses information from the respective electrical load unit to drive the associated switch. Thus, each of the electrical load units may be configured to drive the respective associated switch exclusively with information from the respective electrical load unit. This can mean that the supply system is configured to be operated without any communication links between the electrical load units. Each of the electrical load units may thus be configured to drive the associated switch without information from other electrical load units. The supply system may be free of any communication links between the electrical load units.

If a short circuit occurs in one of the electrical load units or in one of the electrical loads, the current along the supply path will rise sharply and the voltage will be greatly reduced. This means that not all electrical load units can be supplied with a predefinable voltage from the voltage supply anymore. Due to the fact that each one of the electrical load units comprises a switch, the electrical load unit where a short circuit occurs may be electrically decoupled from the other electrical load units by opening switches. If the switches of the electrical load units that are arranged adjacent to the electrical load unit with a short circuit are opened, the electrical load units that are closer to the voltage supply than the affected electrical load unit may continue to be supplied with electrical voltage. This means that in the event of a short circuit in one of the electrical load units, not the entire supply path necessarily fails. Only the electrical load unit wherein the short circuit occurs, and the electrical load units that are located further away from the voltage supply will fail.

Advantageously, the structure of the supply system described herein allows improved protection against failures with one supply path only. A second supply path is not required in this case. The electrical load units which are arranged closer to the voltage supply can continue to be supplied with voltage, by opening the switches of the electrical load units which are arranged adjacent to the electrical load unit with short circuit. Since only one supply path is required, material for electrical lines or connections can be saved.

Another advantage of the supply system described herein is that by opening the switches of the electrical load units that are arranged adjacent to the electrical load unit with a short circuit, the short circuit that occurs may be localized. This simplifies the repair of the supply system.

Since the switch is driven autonomously by the respective electrical load unit, communication between the electrical load units is not necessary. In the event of a short circuit, the respective associated switch is opened by those electrical load units which detect a voltage drop, and an exchange of data between the electrical load units is not required.

According to at least one embodiment of the supply system, the supply system comprises at least one voltage supply having a voltage source and at least two electrical load units, the electrical load units each having a first input and a second input, each of the electrical load units having a switch which is arranged between the respective first and the respective second input, at least one electrical load unit being electrically coupled to the voltage supply, the electrical load units being electrically connected in series, and each of the electrical load units being configured to drive the respective associated switch autonomously.

According to at least one embodiment of the supply system, the supply system comprises at least one further voltage supply with a further voltage source. The further voltage supply may have a similar or the same structure as the voltage supply. The further voltage supply may be configured to provide electrical voltage. The electrical voltage may be predefinable. At least one of the electrical load units is electrically coupled to the further voltage supply. This can mean that at least one of the electrical load units is electrically connected to the further voltage supply. The further voltage supply may be connected to a side of the supply path facing away from the voltage supply. This can mean that the voltage supply is electrically connected to a first electrical load unit and that the further voltage supply is electrically connected to the last of the consecutively arranged electrical load units.

In the event of an interruption of the supply path, for example, in the area of one of the electrical connections between the electrical load units, the electrical load units may continue to be supplied with electrical voltage from the voltage supply and the further voltage supply. Advantageously, the supply system thus shows improved protection against failures, in particular against interruptions along the supply path.

According to at least one embodiment of the supply system, each switch is driven exclusively by information from the associated electrical load unit. This means that each of the electrical load units is configured to drive the respective associated switch autonomously. No information from other electrical load units is required to drive the switch. Thus, the supply system may be configured to be operated without communication links between the electrical load units. Advantageously, the supply system is therefore more robust against failures and no communication infrastructure between the electrical load units is required.

According to at least one embodiment of the supply system, the voltage supply comprises a current limitation or a power limitation. This can mean that the current occurring at the output of the voltage supply is limited to a maximum permissible current or that the power provided at the output of the voltage supply is limited. In the event of a short circuit in one of the electrical load units, the current in the supply path increases sharply. Since the current occurring at the voltage supply is limited by the current limitation, there will be a sharp drop in voltage along the supply path. Thus, a sharp drop in voltage may be used as an indicator for an existing short circuit.

According to at least one embodiment of the supply system, in each case two electrical load units are electrically connected to one another via a supply line. This means that one supply line is arranged between two electrical load units in each case. A first electrical load unit can be electrically connected to the voltage supply via a supply line. Another electrical load unit may be electrically connected to the further voltage supply via a further supply line. For example, the second input of the first electrical load unit can be electrically connected to the first input of a second electrical load unit via a supply line. The supply path thus comprises the supply lines. Advantageously, only one supply path is required.

According to at least one embodiment of the supply system, in each case two electrical load units are electrically connected to one another via exactly one supply line. This means that in each case two electrical load units are electrically connected to one another other via only one supply line. A supply line may be an electrical connection with two electrical lines. One of the two electrical lines may be electrical grounding. Furthermore, it is possible that for all electrical load units exactly one supply line is arranged between each two electrical load units. Advantageously, no second supply path and no communication link between the electrical load units is required either. Thus, costs and material may be saved in the manufacture of the supply system.

According to at least one embodiment of the supply system, the electrical loads each comprise an inductive sensor. For example, the inductive sensor may be a wheel sensor for detecting wheels of trains. The wheel sensor may be arranged on tracks. In addition, the wheel sensor may be configured to detect wheels of trains. Thus, the electrical loads may have distances of several meters or kilometers between one another. The supply system may extend over a length of several 100 meters or several kilometers. Since high safety standards are necessary in the field of train detection, it is advantageous that the supply system shows improved protection against failures.

According to at least one embodiment of the supply system, each of the electrical load units comprises an energy storage. For example, the energy storage may be a capacitor. The energy storage may be electrically connected to the first input and the second input of the electrical load unit. The energy storage may also be electrically connected to the drive unit, so that the drive unit can be supplied with electrical voltage from the energy storage. The energy storage may be configured to store electrical charge. For example, the energy storage may be charged as soon as an electrical voltage is applied to the inputs of the electrical load unit. Furthermore, the energy storage may be electrically connected to the inductive sensor. The energy storage may be configured to supply the inductive sensor with electrical voltage at least temporarily.

Since each one of the electrical load units comprises an energy storage, the electrical load units may also be supplied with voltage from the respective energy storage in case that less or no voltage is provided by the voltage supply in the short term.

According to at least one embodiment of the supply system, the first inputs and the second inputs are each electrically connected to an electric valve. The electric valve may be configured to be permeable to electric current in one direction and impermeable or less permeable to electric current in the opposite direction. In addition, the electric valve may be electrically drivable. The electric valve is arranged such that it is interconnected from the supply line to the electrical load unit in the forward direction. This ensures that the electrical load units can be supplied with voltage from the voltage supply and that there is no current flow from the electrical load units to the voltage supply.

According to at least one embodiment of the supply system, the electric valves each have a diode or a transistor. The diodes are polarized in such a way that they are interconnected from the supply line to the electrical load unit in forward direction. This ensures that the electrical load units can be supplied with voltage from the voltage supply and that there is no current flow from the electrical load units to the voltage supply. The diodes may be semiconductor diodes. The transistors may be metal oxide semiconductor field-effect transistors (MOSFETs).

According to at least one embodiment of the supply system, a resistor is connected in parallel with each switch. The resistor is a charging resistor. The resistor may have a high electrical resistance. When the switch is open, provided there is no short circuit in the respective electrical load unit, input capacitances of the electrical load unit can be partially charged, so that the voltage drop is limited when the switch is closed.

According to at least one embodiment of the supply system, each one of the electrical load units comprises a measuring device which is configured to determine the voltage applied to the respective electrical load unit. For example, the measuring device may be configured to determine the voltage applied to the electrical load unit at the first input and at the second input. If a fault occurs in the supply system, the voltage at the electrical load unit may change. For example, if a short circuit occurs in another electrical load unit, the voltage decreases substantially and the switches of the neighboring electrical load units are opened.

According to at least one embodiment of the supply system, each of the electrical load units is adapted to drive the respective associated switch in dependence of the voltage applied to the respective electrical load unit. This can mean that the switch is opened as soon as the voltage applied to the electrical load unit falls below a predefinable minimum value. If the applied voltage falls below the minimum value, there may be a short circuit in one of the other electrical load units. It is possible for the drive unit of the electrical load unit to be configured to drive the respective switch depending on the voltage applied to the respective electrical load unit. A short circuit in the supply system may lead to a voltage drop in several supply units, so that several switches are opened. This means that a supply unit can be located between two supply units where the switches are open. In this case, the supply unit in the middle can no longer be supplied with voltage via the supply line. As soon as the switches of the two adjacent electrical load units are open, the electrical load unit between these two electrical load units can be supplied with electrical voltage via the energy storage. Thus, the electrical load unit can continue to be supplied with voltage even in the event of a short circuit in another electrical load unit.

Furthermore, it is possible that the switch is closed again as soon as the voltage applied to the electrical load unit again exceeds a predefinable threshold value. For example, this may be the case when the switches of the two electrical load units, which are arranged adjacent to the electrical load unit with short circuit, are opened and the voltage provided by the voltage supply increases again. By opening the switches, the electrical load unit with short circuit is decoupled from the supply system. This means that the other electrical load units can be regularly supplied with voltage from the voltage supply. When the supply system comprises one voltage supply, all electrical load units that are located closer to the voltage supply than the electrical load unit where the short circuit is present can continue to be regularly supplied with voltage. When the supply system comprises one voltage supply and one further voltage supply, all other electrical load units can continue to be supplied with voltage in case there is a short circuit in one of the electrical load units or in one of the supply lines. Thus, the supply system shows improved protection against failures.

In addition, a method for operating a supply system described herein is provided.

According to at least one embodiment of the method, the associated switch is opened for each electrical load unit when the voltage applied to the electrical load unit is below a predefinable minimum value. For example, the voltage applied to the electrical load unit may fall below the minimum value when a short circuit occurs in another electrical load unit. In this case, it is advantageous to at least temporarily disconnect the electrical load unit with a short circuit from the supply system by means of opening the switch of the neighboring electrical load unit or the switches of the two neighboring electrical load units. This prevents a voltage drop at the electrical load unit or at the inductive sensor of the electrical load unit. Furthermore, it is possible that the voltage applied to the electrical load unit falls below the minimum value when a short circuit occurs in the supply line. In this case, it is advantageous to open the switches of the electrical load units that are arranged adjacent to the short circuit. Thus, the remaining electrical load units can continue to be supplied with voltage from the voltage supply.

According to at least one embodiment of the method, the associated switch is opened after a predefinable period of time when the voltage applied to the electrical load unit is below a predefinable minimum value. This may mean that the associated switch is opened only when the voltage applied to the electrical load unit has been below the minimum value for a predefinable period of time. This prevents the switch from being opened during short-term voltage fluctuations. Short-term voltage fluctuations may occur along the supply path, even if there is no short circuit. In this case, the associated switch is opened only after the predefinable period of time when the voltage applied to the electrical load unit is below the minimum value within this period of time.

According to at least one embodiment of the method, the switch is closed at predefinable time intervals after the switch has been opened when the voltage applied to the respective electrical load unit is above a predefinable threshold value. This can mean that the switch is closed as soon as the voltage applied to the electrical load unit is above the threshold value. If the voltage across the electrical load unit subsequently falls below the minimum value again, the switch may be opened again. If the voltage across the electrical load unit does not fall below the minimum value again, the switch may remain closed. This enables that the electrical load units without a short circuit can continue to be regularly supplied with voltage from the voltage supply as soon as the switches of the electrical load units adjacent to the electrical load unit with a short circuit are opened.

The supply system described herein and the method for operating a supply system described herein will be explained below in more detail in connection with embodiments and the pertinent Figures.

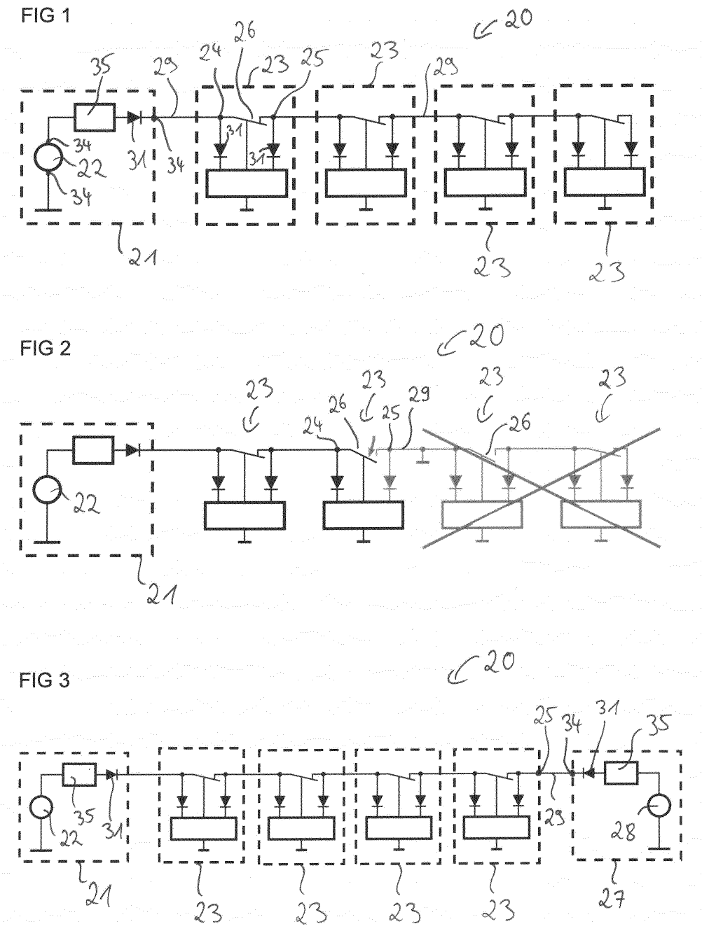

FIGS. 1 and 2 show an exemplary embodiment of the supply system for supplying electrical voltage.

FIGS. 3, 4 and 5 show a further exemplary embodiment of the supply system.

FIGS. 6, 7 and 8 show exemplary embodiments of an electrical load unit.

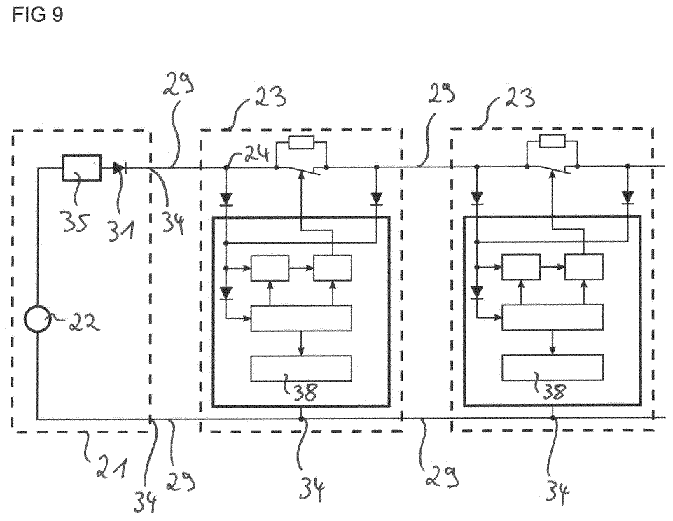

FIG. 9 is a detail of another exemplary embodiment of the supply system.

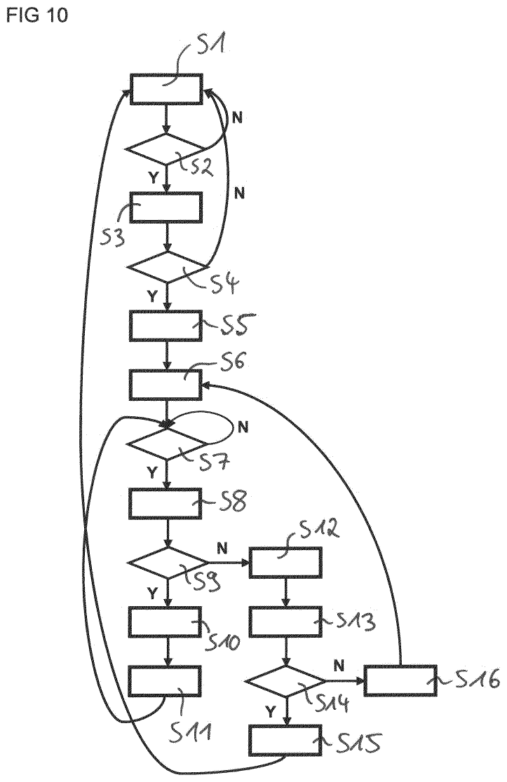

FIG. 10 describes an exemplary embodiment of the method for operating a supply system.

FIG. 1 shows an exemplary embodiment of a supply system 20 for supplying electrical voltage. The supply system 20 comprises a voltage supply 21 comprising a voltage source 22. The voltage source 22 comprises two outputs 34. One of the outputs 34 is grounded and the other one of the outputs 34 is electrically connected to a current limitation unit 35. Alternatively, it is possible that the voltage supply 21 comprises a power limitation unit instead of the current limitation unit 35. In addition, the voltage supply 21 has an output 34. The current limitation unit 35 is configured to limit the current occurring at the output 34 of the voltage supply 21 to a maximum permissible current. If the voltage supply 21 has a power limitation unit, the latter is configured to limit the power occurring at the output 34 of the voltage supply 21 to a maximum permissible power. A diode 31 is arranged between the current limitation unit 35 and the output 34 of the voltage supply 21. The current limitation unit 35 is electrically connected to the diode 31 and the diode 31 is electrically connected to the output 34 of the voltage supply 21. The diode 31 is polarized such that it is interconnected from the current limitation unit 35 to the output 34 in a forward direction.

Furthermore, the supply system 20 comprises at least two electrical load units 23, in this case four electrical load units 23. The electrical load units 23 are electrically connected to the voltage supply 21. The electrical load units 23 are arranged in series. Each of the electrical load units 23 has a first input 24 and a second input 25. The first input 24 of one of the electrical load units 23 is electrically connected to the output 34 of the voltage supply 21. The first input 24 of one of the electrical load units 23 is electrically connected to the output 34 of the voltage supply 21 via a supply line 29. The second input 25 of this electrical load unit 23 is electrically connected to the first input 24 of another electrical load unit 23 via another supply line 29. This means that a supply line 29 is arranged between each two electrical load units 23. In each case, two electrical load units 23 are electrically connected to one another via exactly one supply line 29. Advantageously, no second supply line 29 is required between two electrical load units 23. A supply line 29 may have two electrically conductive cables or wires.

Each of the electrical load units 23 has a switch 26 which is arranged between the respective first input 24 and the respective second input 25. The switches 26 are electrically connected in series. Two switches 26 each are connected to one another via a supply line 29. The first inputs 24 and the second inputs 25 are each electrically connected to a diode 31. In addition, each of the electrical load units 23 is configured to autonomously drive the respective switch 26. The structure of the electrical load units 23 is shown in FIGS. 6 to 9.

The electrical load units 23 each have an electrical load 38. The electrical loads 38 may each have an inductive sensor. The sensors may be wheel detectors for the detection of trains, which are arranged along tracks. Thus, the supply lines 29 between the electrical load units 23 may each have lengths of several meters, several hundred meters or several kilometers.

FIG. 2 shows the exemplary embodiment shown in FIG. 1. There is a short circuit to ground in the supply line 29 between the second electrical load unit 23 from the left and the third electrical load unit 23. The electrical load units 23 are configured to measure the voltage applied to the electrical load unit 23. For this purpose, the voltage present between one of the diodes 31 and ground is determined in each case. If a short circuit occurs, the current rises sharply and the voltage drops. The electrical load units 23 are configured to drive the respective associated switch 26 depending on the voltage applied to the respective electrical load unit 23. Due to the short circuit in the supply line 29, the voltage applied to the second electrical load unit 23 from the left falls below a predefinable minimum value. Therefore, the associated switch 26 is opened. Furthermore, it is possible that for several electrical load units 23 the applied voltage falls below a predefinable minimum value and that therefore several switches 26 are opened. For example, the associated switch 26 is also opened for the third electrical load unit 23 due to the voltage drop. As long as the short circuit in the supply line 29 continues to exist, the third electrical load unit 23 and the fourth electrical load unit 23 can thus no longer be supplied with voltage from the voltage supply 21.

However, by opening the switch 26 of the second electrical load unit 23, the short circuit in the supply line 29 is decoupled from the voltage supply 21. Therefore, the first electrical load unit 23 and the second electrical load unit 23 can continue to be supplied with voltage from the voltage supply 21. The structure of the supply system 20 shown here thus allows at least some of the electrical load units 23 to continue to be supplied with voltage by the voltage supply 21 with a simple connection between the electrical load units 23 even in case of a short circuit in a supply line 29.

FIG. 3 shows a further exemplary embodiment of the supply system 20. In contrast to the exemplary embodiment shown in FIG. 1, the supply system 20 comprises a further voltage supply 27 with a further voltage source 28. The further voltage supply 27 has the same structure as the voltage supply 21. The further voltage supply 27 is arranged on a side of the supply system 20 facing away from the voltage supply 21. The further voltage supply 27 has an output 34 which is electrically connected to the second input 25 of one of the electrical load units 23 via a supply line 29.

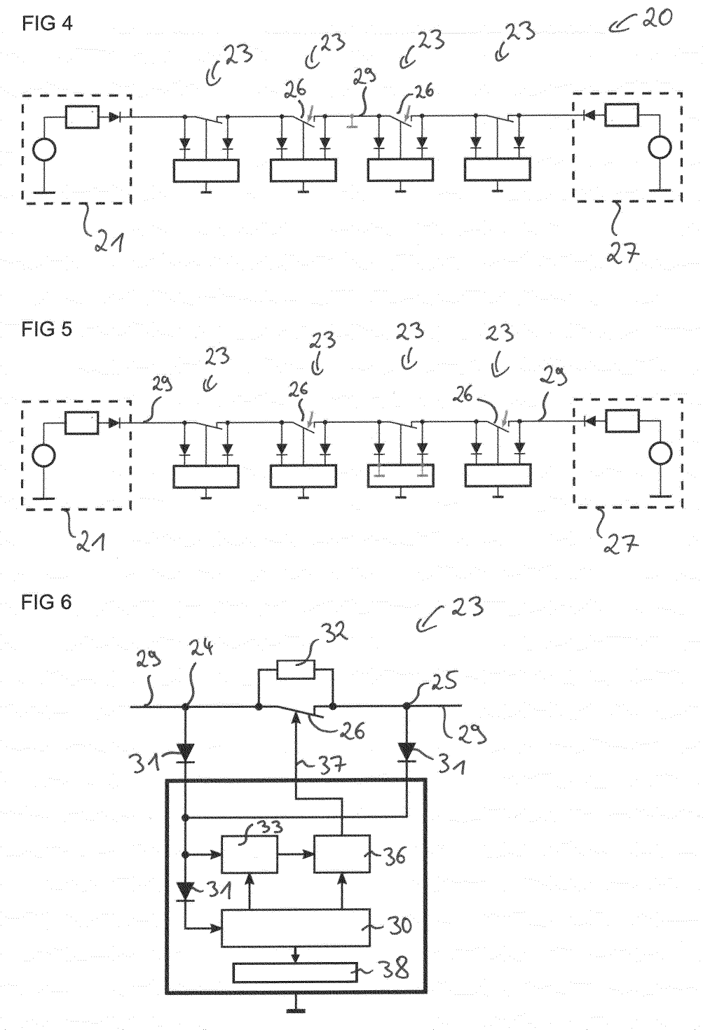

FIG. 4 shows the exemplary embodiment shown in FIG. 3. There is a short circuit to ground in the supply line 29 between the second electrical load unit 23 from the left and the third electrical load unit 23. Upon a voltage drop along the supply line 29, the switches 26 of the second and the third electrical load units 23 remain open. Thus, the short circuit in the supply line 29 is decoupled from the voltage supply 21 and the further voltage supply 27. The first and second electrical load units 23 continue to be supplied with voltage from the voltage supply 21. The third and fourth electrical load units 23 continue to be supplied with voltage from the further voltage supply 27. This means that all electrical load units 23 can continue to be regularly supplied with voltage, even in case of a short circuit in a supply line 29.

FIG. 5 shows the exemplary embodiment shown in FIG. 3. There is a short circuit in the third electrical load unit 23 from the left. Therefore, the voltage along the supply line 29 drops, which is why opening of several switches 26 may occur. Upon opening of the switches 26 on the second electrical load unit 23 and the fourth electrical load unit 23, the remaining switches 26 are successively closed again. Now the first and the second electrical load units 23 can continue to be supplied with voltage via the voltage supply 21. The fourth electrical load unit 23 continues to be supplied with voltage via the further voltage supply 27. The defective third electrical load unit 23 is decoupled from the voltage supply 21 and the further voltage supply 27. Advantageously, this structure of the supply system 20 thus allows only the defective electrical load unit 23 to be decoupled from the supply system 20 and all other electrical load units 23 to be regularly continued to be supplied with voltage. For this purpose, only one supply line 29 is required between the voltage supplies 21, 27 and the electrical load units 23 in each case.

FIG. 6 shows an exemplary embodiment of an electrical load unit 23. The electrical load unit 23 has a first input 24 and a second input 25. The first input 24 and the second input 25 are each electrically connected to a supply line 29. A switch 26 is arranged between the first input 24 and the second input 25. A resistor 32 is connected in parallel to the switch 26. The resistor 32 is a charging resistor. The first input 24 is electrically connected to a diode 31. The diode 31 is further electrically connected to a measuring device 33 and a further diode 31. The measuring device 33 is configured to determine the voltage applied to the electrical load unit 23. The second input 25 is electrically connected to a further diode 31. The further diode 31 is also connected to the measuring device 33 and a further diode 31. Thus, the voltage applied between the electrical load unit 23 and ground is determined in the measuring device 33. The measuring device 33 is connected to a drive unit 36. The drive unit 36 is configured to drive the switch 26. This means that the drive unit 36 can drive the switch 26 in such a way that it is closed or opened. The drive unit 36 is connected to the switch 26 via a control connection 37. The control connection 37 may be a mechanical, an electrical or a wireless connection.

The first input 24 and the second input 25 are each electrically connected to an energy storage 30 of the electrical load unit 23 via two diodes 31 in a forward direction. The energy storage 30 is connected to the measuring device 33 and the drive unit 36. Furthermore, the energy storage 30 is connected to an electrical load 38, such as an inductive sensor. If the voltage at both inputs 24, 25 drops in case of any interference or opening of the switches 26 of adjacent electrical load units 23, the measuring device 33, the drive unit 36 and the electrical load 38 can be supplied with voltage from the energy storage 30.

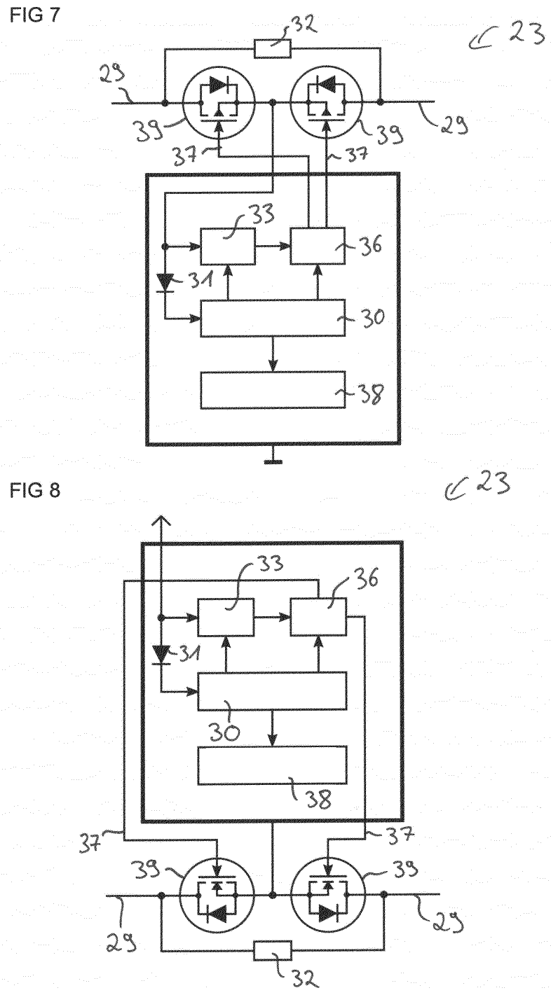

FIG. 7 shows another exemplary embodiment of an electrical load unit 23. Compared to the exemplary embodiment shown in FIG. 6, the electrical load unit 23 has two transistors 39. The transistors 39 are p-channel metal oxide semiconductor field-effect transistors. In this case, the transistors 39 act as an electric valve. In addition, the transistors 39 act as switches. The transistors 39 are each connected to the drive unit 36 via a control connection 37. The drive unit 36 is configured to drive the transistors 39. If no interferences exist in the supply system 20 and the electrical load units 23 are supplied with current via the voltage supply 21, the current can flow via the diode of one of the transistors 39 in the forward direction of the diode, and the other one of the transistors 39 is driven in such a way that the current can continue to flow via it in the same direction to reach the next electrical load unit 23. To stop the current flow, said transistor 39 may be driven in such a way that the current cannot flow any further. This corresponds to the situation in which the switch 26 is open in the exemplary embodiment shown in FIG. 6. For the electrical load unit 23 shown, current flow is possible in both directions. Advantageously, the transistors 39 may be driven in such a way that the voltage drop at the diode 31 of the electrical load unit 23 is short-circuited. This increases the electrical efficiency.

FIG. 8 shows another exemplary embodiment of an electrical load unit 23. Compared to the exemplary embodiment shown in FIG. 7, the electrical load unit 23 is connected to the other pole of the voltage supply 21 via the supply line 29. In this case, the transistors 39 are n-channel metal oxide semiconductor field-effect transistors. Instead of being connected to the supply lines 29, the diode 31 and the measuring device 33 are connected to a return line to the voltage supply 21 or to a reference potential. This exemplary embodiment has the advantage over the exemplary embodiment shown in FIG. 7 that no level converter is required. Instead, the transistors 39 can be driven directly by the drive unit 36. In the exemplary embodiment in FIG. 7, a level converter is required to drive the transistors 39 in the case of high voltages.

FIG. 9 shows a detail of a further exemplary embodiment of the supply system 20. The supply system 20 has the voltage supply 21 and at least two electrical load units 23. In addition to the electrical load units 23 shown, the supply system 20 may have further components. Each of the electrical load units 23 is connected to both poles of the voltage supply 21. This means that each of the electrical load units 23 is connected to both outputs 34 of the voltage supply 21. The first electrical load unit 23 is connected to each of the two outputs 34 of the voltage supply 21 via two supply lines 29. The first input 24 of the electrical load unit 23 is connected to an output 34 of the voltage supply 21 via a supply line 29. In addition, an output 34 of the electrical load unit 23 is connected to an output 34 of the voltage supply 21 via a supply line 29. The second electrical load unit 23 is connected via two supply lines 29 and the first electrical load unit 23 to the two outputs 34 of the voltage supply 21. Thus, the electrical loads 38 of the electrical load units 23 are electrically connected in parallel. In particular, the electrical loads 38 are electrically connected in parallel with each other with respect to the outputs 34 of the voltage supply 21.

In connection with FIG. 10, an exemplary embodiment of the method for operating the supply system 20 is described. In a first step S1, for each electrical load unit 23, the voltage applied to the electrical load unit 23 is measured by the measuring device 33. In a second step S2, it is determined whether the voltage measured is below a predefinable minimum value. In the event that the measured voltage is below the minimum value, the applied voltage is measured again in a third step S3 after a predefinable period of time. Measuring the voltage twice avoids that a switch 26 is opened already in case of short-term voltage drops in the supply system 20.

If the measured voltage is above the minimum value in the first step S1 already, the first step S1 again follows upon the second step S2. Upon the third step S3, it is determined again in a fourth step S4 whether the voltage measured in the third step S3 is below the minimum value. If now the voltage is above the minimum value, for example, there was a short-term voltage drop in the supply system 20 in step S1. In this case, step Si follows once more. If the voltage is again below the minimum value, the switch 26 is opened in a fifth step S5.

If there occurs an interference or a short circuit in one of the supply lines 29 or in one of the electrical load units 23, the voltage in the supply system 20 may drop sharply, at least in places. In order to protect the intact electrical load units 23 against interferences or short circuits, the associated switches 26 are opened. In a sixth step S6, the electrical load units 23 which are intact and separated from the supply line 29, are supplied with voltage via their own energy storages 30. In a next step S7, the voltage applied to the electrical load unit 23 is measured after a predefinable period of time. If the voltage is below a predefinable threshold value, the switch 26 remains open and step S7 follows once more. If the voltage is above the predefinable threshold value, the switch 26 is closed again in the next step S8. Therefore, it is possible that in this case a defective electrical load unit 23 or a defective supply line 29 is reconnected to an intact supply line 29. In a next step S9, the voltage applied to the electrical load unit 23 is measured. If the voltage is below the predefinable threshold value, the switch 26 is opened again in a next step S10. The switch 26 is not opened again after a predefinable period of time, but instantaneously in order to keep the possible voltage drop at the electrical load unit 23 as short as possible. Provided the interference or short circuit has not yet been rectified, the voltage present at the electrical load unit 23 may continue to be below the threshold value or below the minimum value. In a next step S11, the switch 26 remains open for a predefinable period of time. In the subsequent step S7, the voltage applied is measured again. This means that in the following step S8 the switch 26 may be closed repeatedly for test purposes. In doing so, the predefinable period of time in step S11 may increase over time.

If the voltage measured in step S9 is above the threshold value, the switch 26 remains closed in a next step S12. In a subsequent step S13, the switch 26 remains closed for a predefinable period of time. In a next step S14, the voltage applied to the electrical load unit 23 is measured. If the voltage is below the threshold value, the switch 26 is opened again in a next step S16. Subsequently, in step S6 the intact electrical load units 23, which are separated from the 10 supply line 29, are supplied with voltage via their own respective energy storages 30.

If the voltage measured in step S14 is above the threshold value, the switch remains closed in a next step S15. Step S1 follows again after step 15. If there is a short circuit in one of the electrical load units 23, the associated switch 26 remains open. As soon as the voltage in the supply system 20 is again above the threshold value, the remaining switches 26 are closed again and the remaining electrical load units 23 are again supplied with voltage from the voltage supply 21 and, if necessary, from the further voltage supply 27. If there is a short circuit in one of the supply lines 29, the switches 26 of the adjacent two electrical load units 23 remain open until the short circuit has been rectified. This is achieved by briefly closing the switches 26 of the adjacent two electrical load units 23 for test purposes and by measuring the voltage applied to the two electrical load units 23. During this time, all electrical load units 23 are supplied with voltage from the voltage supply 21 and, if necessary, from the further voltage supply 27. Thus, the supply system 20 shows improved protection against failures.

### LIST OF REFERENCE SYMBOLS

20: supply system
21: voltage supply
22: voltage source
23: electrical load unit
24: first input
25: second input
26: switch
27: further voltage supply
28: further voltage source
29: supply line
30: energy storage
31: diode
32: resistor
33: measuring device
34: output
35: current limitation unit
36: drive unit
37: control connection
38: electrical load
39: transistor
S1-S16: Steps

1. A supply system for supplying electrical voltage, the supply system comprising:
at least one voltage supply which has a voltage source, and
at least two electrical load units, wherein
the electrical load units each have a first input, a second input and an electrical load,
each of the electrical load units has a switch which is arranged between the respective first and the respective second inputs,
at least one electrical load unit is electrically coupled to the voltage supply, the electrical loads are electrically connected in parallel, and
each of the electrical load units is configured to autonomously drive the respective associated switch.

2. The supply system according to claim 1, wherein the supply system has at least one further voltage supply with a further voltage source.

3. The supply system according to claim 1, wherein each switch is exclusively driven by information of the associated electrical load unit.

4. The supply system according to claim 1, wherein the voltage supply comprises a current limitation or a power limitation.

5. The supply system according to claim 4, wherein in each case two electrical load units are electrically connected to one another via exactly one supply line.

6. The supply system according to claim 1, wherein the electrical loads each comprise an inductive sensor.

7. The supply system according to claim 1, wherein each of the electrical load units comprises an energy storage.

8. The supply system according to claim 1, wherein the first inputs and the second inputs are each electrically connected to an electric valve.

9. The supply system according to claim 8, wherein the electric valves each comprise a diode or a transistor.

10. The supply system according to claim 1, wherein a resistor is connected in parallel with each switch.

11. The supply system according to claim 1, wherein each of the electrical load units comprises a measuring device configured to determine the voltage applied to the respective electrical load unit.

12. The supply system according to claim 11, wherein each of the electrical load units is adapted to drive the respective associated switch in dependence of the voltage applied to the respective electrical load unit.

13. A method for operating a supply system according to claim 11, wherein for each electrical load unit the associated switch is opened when the voltage applied to the electrical load unit is below a predefinable minimum value.

14. The method according to claim 13, wherein the opening of the associated switch takes place after a predefinable period of time when the voltage applied to the electrical load unit is below a predefinable minimum value.

15. The method according to claim 13, wherein, after the opening of the switch, the switch is closed at predefinable time intervals when the voltage applied to the respective electrical load unit is above a predefinable threshold value.
